(19) United States
(12) Patent Application Publication
(10) Pub. No.: US 2017/0269947 A1
(43) Pub. Date: Sep. 21, 2017

(54) CUSTOM KIOSK

(71) Applicant: Wal-Mart Stores, Inc., Bentonville, AR (US)

(72) Inventors: Christopher Soames Johnson, Pea Rdige, AR (US); Matthew Jason Sargent, Bentonville, AR (US); Toni H. Tallman, Pea Ridge, AR (US)

(21) Appl. No.: 15/462,998

(22) Filed: Mar. 20, 2017

Related U.S. Application Data
(60) Provisional application No. 62/310,917, filed on Mar. 21, 2016.

(51) Int. Cl. G06F 9/445; G06F 13/40; G06F 13/10; G07D 11/00

(52) U.S. Cl. CPC G06F 9/44505; G07D 11/0036; G06F 13/4081; G06F 13/102; G06F 9/546

(57) ABSTRACT

A system for customizing a kiosk comprises a motherboard and first and second Raspberry Pi type compute modules on the mother board for customizing the mother board. The first compute module performs front end processing for displaying an output to a peripheral device. The second compute module performs back end processing.

### RELATED APPLICATIONS

This application claims the benefit of U.S. Provisional Patent No. 62/310,917, filed Mar. 21, 2016, the contents of which are incorporated herein in its entirety.

### FIELD

The present inventive concepts relate generally to electronic kiosks, and more specifically, to a kiosk architecture including custom compute modules.

### BACKGROUND

Self-service retail shopping interactive systems such as kiosks typically have a monolithic architecture where processing, data exchange, and user interface functions are performed on a motherboard, which resides under the same enclosure with input devices such as touch screens and computer keyboards,

### BRIEF SUMMARY

In one aspect, provided is a system for customizing a kiosk, comprising: a mother board; and first and second Raspberry Pi type compute modules on the mother board for customizing the mother board, the first compute module performing front end processing for displaying an output to a peripheral device, the second compute module performing back end processing.

In some embodiments, the first compute module further performs a rendering of a graphical user interface.

In some embodiments, the mother board includes an open source breakout board to which the first and second Raspberry PI compute modules are electrically coupled to provide an input/output communication exchange.

In some embodiments, the first and second compute modules are removable from the mother board, and replaceable with a different first or second compute module that has a validity key that permits the different first or second compute module to communicate with the original remaining first or second compute module.

In some embodiments, first and second compute modules are paired to the mother board so that the mother board is unusable without a validity exchange of information between the first and second compute modules.

In some embodiments, the mother board includes a printed circuit board (PCB).

In some embodiments, the mother board communicates between an interactive display screen and a solid state drive of the kiosk.

In some embodiments, the second compute module provides data generates a call from the back end processing to the solid state device.

In some embodiments, the second compute module generates a call to a service reads and converts data from the service or a database call into a readable accessible form.

In some embodiments, the system further comprises a remote server for exchanging data with at least one of the Raspberry PI compute modules.

In some embodiments, the first compute module performs an input data conversion for a peripheral device.

In another aspect, provided is a kiosk apparatus, comprising: a mother board; first and second Raspberry Pi type compute modules on the mother board for customizing the mother board, the mother board including an open source breakout board to which the first and second Raspberry PI compute modules are electrically coupled to provide an input/output communication exchange; a solid state drive for storing data for the communication exchange between the first and second Raspberry PI compute modules or to render portions of data or a temporary storage location from a user input to storage back to a central location; and a touchscreen display for displaying a result generated by at least one of the first and second Raspberry Pi type compute modules.

In some embodiments, the mother board includes a printed circuit board (PCB).

In some embodiments, the kiosk apparatus further comprises a module for communicating between the touchscreen display and the solid state drive.

In some embodiments, the kiosk apparatus further comprises a network interface for exchanging data generated by at least one of the Raspberry PI compute modules and a remote server.

In some embodiments, the kiosk apparatus further comprises an NFC reader attached to the custom motherboard.

In some embodiments, the first compute module performs front end processing for displaying an output to a peripheral device, and the second compute module performs back end processing.

In another aspect, provided is a method for displaying information on a kiosk, comprising activating the kiosk; request an action; accepting a user input by a custom mother board in response to activating the kiosk; making a first call to a front end Raspberry Pi compute module; making a first call to a back end Raspberry Pi compute module; processing, at a remote server in communication with the kiosk, an output request in response to the call made to the back end Raspberry Pi compute module; in response to processing the output request, making a second call to the back end Raspberry Pi compute module; making a second call to the front end Raspberry Pi compute module; and displaying information in response to the second call to the front end Raspberry Pi compute module

In some embodiments, the requested action includes a request to scan an item for a price. The custom mother board accepts an input for a price scan. The first call to the front end Raspberry Pi compute module includes a call to accept input and relay data for larger data sets or for temporary storage use a solid state device. Formatted data is transferred from the front end Raspberry Pi compute module to the back end Raspberry Pi compute module. The transferred formatted data includes information related to an action to perform a price lookup. A service call is made on the server to perform the price lookup. A result is provided from the server to the back end Raspberry Pi compute module, including price for item data for larger data sets or for temporary storage use a solid state device. The price is provided for item data from the back end Raspberry Pi compute module to the front end Raspberry Pi compute module. The item price information is rendered by a kiosk display and the price associated with the item is displayed.

In some embodiments, the first call is made to a front end Raspberry Pi compute module to accept the user input and store that onto a solid state drive (SSD) or accept a scan from a reader and convert that into usable data store it on the SSD.

In some embodiments, the second call is made to the back end Raspberry Pi compute module to take the data that was requested and convert from a database or service information to something more manageable for the program and store that information back onto the SSD

In some embodiments, the second call is made to the front end Raspberry Pi compute module to take the data from the back end Raspberry Pi compute module and make it consumable by the customer/user and render it out on the display or print a receipt or report on paper or out through another device for user consumption.

In some embodiments, the method further comprises performing an information exchange between the front end and back end Raspberry Pi compute modules, wherein the mother board so that the mother board is unusable in the absence of the information exchange.

In some embodiments, at least one of the front and back end Raspberry Pi compute modules is replaceable with a different first or second compute module that has a validity key that permits the different first or second compute module to communicate with the original remaining first or second compute module.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a block diagram of a circuit board in which embodiments can be practiced.

FIG. 2 is a block diagram of a kiosk, including connections between a circuit board and other structural elements of the kiosk, in accordance with some embodiments.

FIG. 3 is a diagram illustrating data exchanges between various elements of a retail shopping environment, in accordance with some embodiments.

FIG. 4 is a diagram illustrating data exchanges between various electronic elements of a retail shopping environment, in accordance with other embodiments.

### DETAILED DESCRIPTION

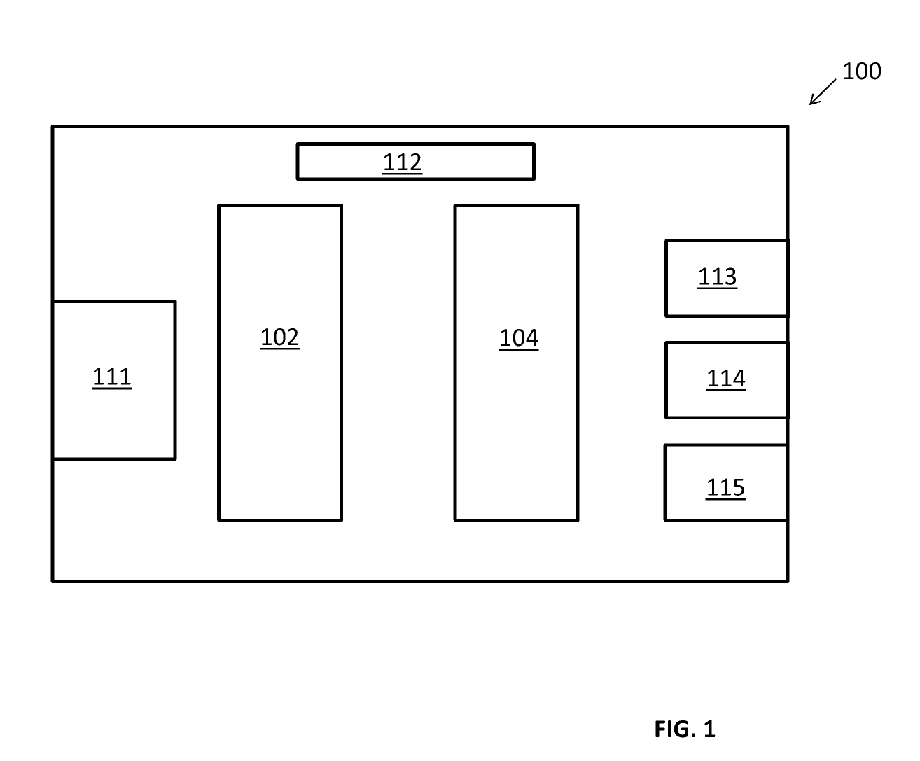

FIG. 1 is a block diagram of a circuit board 100 in which embodiments can be practiced. The circuit board 100 is preferably a custom printed circuit board (PCB), but not limited thereto. The circuit board 100 is constructed and arranged for being positioned in a kiosk housing, along with a display screen, storage device, and associated cables, connection ports, and related hardware and software components. In some applications, a customer can use an in-store interactive device that includes the circuit board 100 to retrieve a result to a request made electronically, for example, product inquires, price information, location information, self-checkout, and so on. In other applications, an interactive device including the circuit board 100 can be positioned at an airport, public building, bank, school, or other location.

Various components are employed are employed on the circuit board 100, in particular, a first compute module 102 and a second compute module 104. Other components may include but not be limited to a solid state drive (SSD) connector 111, a display connector 112, a network connector 113, a wireless device interface 114, and a power connector 115. The circuit board 100, also referred to as a motherboard, may include at least one processor, peripheral controller, logic chips, bus protocol circuitry, graphics processing memory management chips, and so on. One or more of these other elements may be on the first and/or second compute modules 102, 104.

The SSD connector 111 is for facilitating a communication between a storage device such as an SSD and the first and second compute modules 102, 104. For example, the SSD connector 111 can exchange data stored at an SSD with the first and second compute modules 102, 104. As described above, the first compute module 102 may perform data rendering functions. The SSD may serve as a drop location for stored data before it is rendered by the first compute module 102. The SSD connector 111 can establish a communication path between the SSD storing the data and the first compute module 102 which renders the data, for example, renders graphical data. The SSD connector 111 can also establish a communication path between the SSD data and the second compute module 104 to provide stored data at the SSD to a server 220 or other remote storage device for long-term storage.

The display connector 112 is provided for communicating with an electronic display, for example, an interactive or touchscreen display.

The network connector 113 may include an Ethernet connector or other network connector for providing electronic communications between elements of the circuit board 100 and other devices via a communications network, for example, remote services, databases, and so on. For example, the circuit board 100 or other kiosk devices may include software that can be upgraded remotely via the network connector 111 in wired or wireless communication with a network through which upgrade software may be transmitted to the circuit board 100.

The wireless device connector 114 may include a near field communication (NFC) connector, a radio frequency identification (RFID) connector, or the like for coupling with an NFC scanner, an RFID reader, and/or other scanning device(s). Other devices may include card readers, thumbprint scanners or other biometric devices, cash deposit mechanisms, and so on. The wireless device connector 114 may include a physical conductive conduit for exchanging signals, power and so on with one or more wireless devices.

The power connector 115 receives power from a power source, such as an electrical outlet, and distributes the power to the electronic components of the circuit board 100. A cable or cord with an end for inserting in an electric outlet or the like may be provided, but not limited thereto.

The first and second compute modules 102, 104 are constructed and arranged for communicating between the various input/output ports or connectors 111, 112, 113, 114, 115 and/or other ports that establish communication with other kiosk hardware components, such as a keyboard, mouse, trackball, credit card reader, and so on. In some embodiments, the first and second compute modules 102, 104 are Raspberry Pi (RPI) type modules for customizing the mother board 100. These other kiosk hardware components are arranged to capitalize on the inherent features of the RPI modules. As described herein, the RPI modules may each perform a different function, each exchanging data with different other kiosk hardware components. The RPI modules 102, 104 may each include a processor, random access memory (RAM), connectors, and so on. In some embodiments, the first and/or second compute modules 102, 104 include open source breakout modules, for example, which can be electronically coupled to an I/O board or the like. The first and second compute modules 102, 104 may be removable, for example, plugged into a compatible connector at the circuit board 100 but unplugged from the circuit board 100 in cases of replacement. The compute modules 102, 104 may be constructed and arranged to operation an open source environment, but allow for customer facing retail kiosk implementations executing an open-source, cross-platform JavaScript runtime environment, such as Node.js. In addition, communication may be established with local storage in communication with a central set of services to provide data required by a kiosk user.

In some embodiments, the first compute module 102 performs front end processing for displaying an output to a peripheral device, e.g., electronic display, SSD, and so on via one or more of the connectors 111, 112, 113, 114, 115 and/or other ports that establish communication with other kiosk hardware components. For example, the first compute module 102 may perform processing related to display input/output, input data conversions for peripheral devices, and so on. The second compute module 104 performs back end processing, caching, and intermediate computation. Intermediate computation may include examples such as the aggregation of sales information for a display, the listing of site locations that contain an item, or other computations that receive and convert service call information into something more consumable for the front-end to display. In another example, the second compute module 104 may generate and output calls out to services, providing information to a storage device such as an SSD, reading and converting data received from service or database calls into a more readable accessible form. As mentioned above, in some embodiments, the first and second compute modules 102, 104 are removable from the circuit board 100. The compute modules 102, 104 may include a validity key or other authentication code, imprint, identifier, and so on that distinguishes the compute modules, and also permits the compute modules to operate, for example, exchange data with each other and to other devices in the system when valid, while preventing them from operating when a detector establishes that the validity key or the like is not valid for permitting option. Thus, the first and second compute modules 102, 104 may be paired to the mother board so that the mother board is unusable without a validity exchange of information between the first and second compute modules. A validation feature may be present on the circuit board 100 that establishes whether a compute module 102, 104 is valid for pairing with the other of the compute modules 102, 104.

Accordingly, either or both compute modules 102, 104 can be replaced with a different first or second compute module that has a validity key that permits the different first or second compute module to communicate with the original remaining first or second compute module.

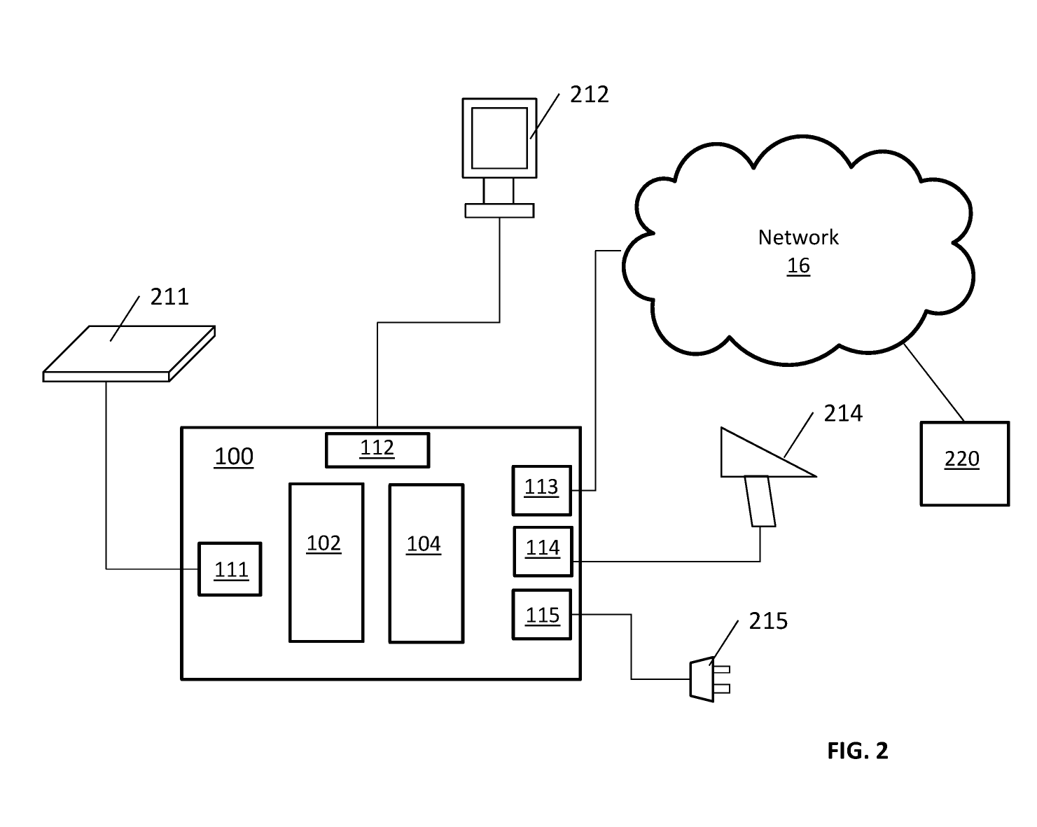

As shown in FIG. 2, the various connectors of the circuit board 100 can be electrically coupled to other elements of a kiosk. As shown in FIG. 2, the circuit board 100 can be collocated with an SSD 211, display 212, input device 214 such as a scanner, power adapter 215, and/or other kiosk elements such as a memory card reader, infrared reader for accepting digitally recorded photographs from a digital camera, a mechanism for accepting payment in currency and/or by credit card, and other communications interfaces for communicating with one or remotely located computers in an enclosure, or housing, to form a kiosk or related interactive display apparatus.

In particular, the SSD connector 111 can be connected via conductive wires or other connectors to an SSD 211, the display connector 112 can be connected via conductive wires or other connectors to a kiosk display 212, the network connector 113 can be connected to a network 16, the wireless device connector 114 may include a near field communication (NFC) connector, a radio frequency identification (RFID) connector, or the like for coupling with compatible input device 214 such as an NFC scanner, an RFID reader, and/or other scanning device(s), and the power connector 115 may be connected to a power cord, adapter 215, or the like for receiving power, i.e., voltage and current, from a power source.

As described herein, a feature of a kiosk or related apparatus constructed and arranged to include two RPI compute modules instead of a single CPU permits front end processing to occur at the same time, or near simultaneously, as back end processes, which may result in a 20-30% gain in performance since front end input processing need not cease while performing back end lookup/card processing, and does not require computation from either the front end or back end processing to be stopped.

Another technical advantage of having a custom board and multiple RPI compute modules is that the processing, data lookup, card processing, and so on can be performed with respect to simulations to front end rendering of the visual aspects of the kiosk or taking user input without a requirement to wait for asynchronous processing between the two RPI compute modules and storage of that information and transfer between processing using a solid state drive or other storage device.

By way of example, a user may operate a device using a barcode reader or other scanning device for collecting data such as a barcode label using one RPI compute module, for example, a first or front end RPI compute module. Data is written to a solid state drive on required data for processing. At the same time, the back end RPI compute module determines that a price check request was made, whereby a lookup for the device may be performed, for example, first searching for cached prices on a local computer if not generating a request to the back end database that holds the price data. At the same time, the front end RPI compute module sends messages to the customer, or performs a different lookup function, for example, such as checking a status of a layaway item, online purchased item, and so on. When the second or back end RPI compute module finds the price either in cache locally or response from the server, it writes that information to the solid state drive in an output directory. The first RPI compute module retrieves the result to process it back to the user.

Here, the computer processing is improved with respect to the speed of customer interaction since a single CPU would otherwise perform the foregoing and the RPI compute modules alleviate the CPU to perform other tasks. In another example, a custom PCB includes three RPI compute modules: one to run caching constantly or the ability to repurpose the machine to perform multiple functions such as display and dispense products as well as be price checker, checkout location, lottery ticket dispenser. An RPI module switch may operate to program the module to perform a different role or functionality change and be easily modular so if a replacement in compute modules maybe performed. The custom PCB in this example may also promote or enhance the communications between the compute modules, for example, monitoring for when there are interrupts like something in the input or output folders.

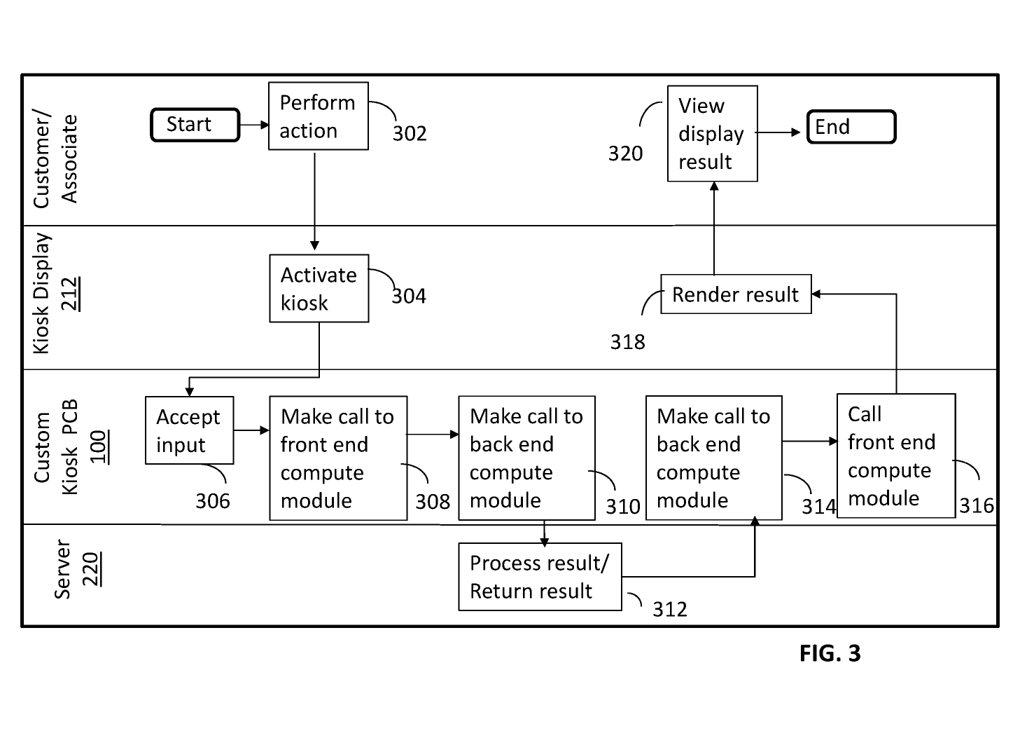

FIG. 3 is a diagram illustrating data exchanges between various elements of a retail shopping environment, in accordance with some embodiments. The retail environment may include a remote server 220, a custom kiosk circuit board 100, and a kiosk display 212. Although FIG. 3 refers to kiosk components, other related interactive devices may equally apply. In describing the data exchanges, reference is made to elements of FIGS. 1 and 2.

At block 302, a user such as a store customer or employee/associate desires to perform an action that requires the use of a self-service retail shopping interactive system, such as a kiosk illustrated in FIG. 2.

At block 304, the user activates the kiosk by selecting an option corresponding to the desired action at the kiosk display 212 to generate an input that is output to the circuit board 100 of the kiosk.

At block 306, the input is received, accepted, and processed by the circuit board 100, for example, by one or more processors of the circuit board 100.

At block 308 a call is made to a front end, or first, compute module 102 of the circuit board 100. The call may include a call to accept user inputs, for example, received from a keyboard, interactive display, mouse, touch wheel, or other input device, and relay data for larger data sets or for temporary storage. Data related to the call may be stored at the SSD 211 and/or server 220. In some examples, the call may be made to the first compute module 102 to accept a scan from a universal product code (UPC) or NFC reader or related device and convert the scan data into usable data, which may be stored at the SSD 211 or other storage device.

At block 310, a call is made to a back end, or second, compute module 104. The call to the second compute module 104 may take the information location rom the first compute module 102 and provide this to the back end compute module 104 for a service call or database call to retrieve information. For example, in situations where a large payload is processed and needed to communicate between the two compute modules 102, 104, the information can be temporarily stored at the SSD, and a reference to the information location may be provided to the second compute module as the data payload.

At block 312, a remote server 200 or related computer may process an output request in response to the first call at block 310 made to the back end compute module 104. This may include information needed for the request that is in communication with or linked into the other systems like item information (price, quantity, description, size, color, etc), store information, sales, associate information, or something else that has a change frequency.

At block 314, a second call is made to the back end compute module 104, for example, to return a result generated at block 312 to the back end compute module 104.

At block 316, a second call is made to the front end compute module 102, for example, to return the result received by the back end compute module 104 and to format the result for display at the display 212. At block 318, the display 212 renders the result. At block 320, the user can view the information displayed in response to the processing performed on the result at the display 212.

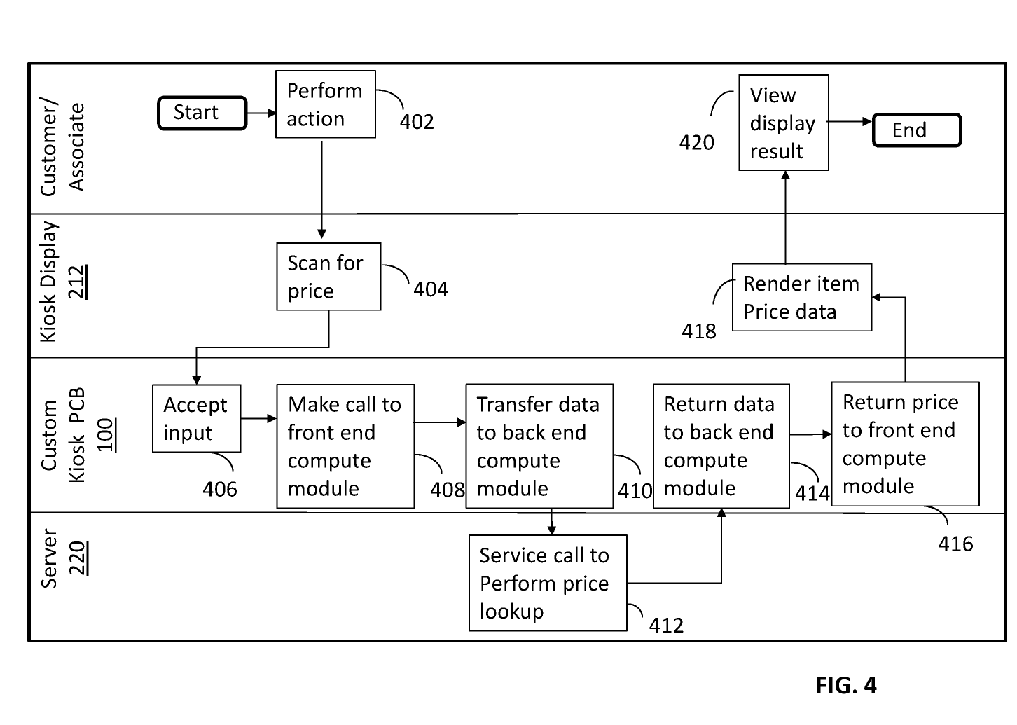

FIG. 4 is a diagram illustrating data exchanges between various elements of a retail shopping environment, in accordance with other embodiments. The retail environment may include a remote server 220, a custom kiosk circuit board 100, and a kiosk display 212. Although FIG. 3 refers to kiosk components, other related interactive devices may equally apply. In describing the data exchanges, reference is made to elements of FIGS. 1 and 2.

At block 402, a user such as a store customer or employee/associate desires to scan a store item for a price. Other user actions may equally apply. In doing so, at block 404, the user touches the kiosk display 212 and selects displayed options, for example, touching the display, or using a mouse, keyboard, and so on. The kiosk may include a scanner 214 for receiving barcode data or the like from an item of interest, which can be used to determine the requested price.

At block 406, the input is received, accepted, and processed by the circuit board 100, for example, by one or more processors of the circuit board 100.

At block 408 a call is made to a front end, or first, compute module 102 of the circuit board 100. The call may include a call to accept user inputs regarding price requests. The price data may be stored at the SSD 211 and/or server 220. The scan data can be converted into storable price data, which may be stored at the SSD 211 or other storage device.

At block 410, a call is made to a back end, or second, compute module 104. The call to the second compute module 104 may include the transfer of formatted data including actions to perform, and a request for a price lookup.

At block 412, a remote server 200 or related computer may process the request in response to the call at block 410 made to the back end compute module 104. Here, a service call on the server 200 may be made to perform a price lookup function.

At block 414, data from the processed request, e.g., price lookup result, is returned to the back end compute module 104.

At block 416, a second call is made to the front end compute module 102, for example, to return the price lookup result received by the back end compute module 104 and to format the result for display at the display 212. At block 418, the display 212 renders the item price information. At block 320, the user can view the information displayed in response to the processing performed on the result at the display 212.

As will be appreciated by one skilled in the art, aspects of the inventive concepts may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

The foregoing and other features and advantages of the invention will be apparent to those of ordinary skill in the art from the following more particular description of the invention and the accompanying drawings.

A number of implementations have been described. Nevertheless, it will be understood that the foregoing description is intended to illustrate and not to limit the scope of the inventive concepts which are defined by the scope of the claims. Other examples are within the scope of the following claims.

What is claimed is:

1. A system for customizing a kiosk, comprising:
a mother board; and
first and second Raspberry Pi type compute modules on the mother board for customizing the mother board, the first compute module performing front end processing for displaying an output to a peripheral device, the second compute module performing back end processing.

2. The system of claim 1, wherein the first compute module further performs a rendering of a graphical user interface.

3. The system of claim 1, wherein the mother board includes an open source breakout board to which the first and second compute modules are electrically coupled to provide an input/output communication exchange.

4. The system of claim 3, wherein the first and second compute modules are removable from the mother board, and replaceable with a different first or second compute module that has a validity key that permits the different first or second compute module to communicate with the original remaining first or second compute module.

5. The system of claim 3, wherein the first and second compute modules are paired to the mother board so that the mother board is unusable without a validity exchange of information between the first and second compute modules.

6. The system of claim 1, wherein the mother board includes a printed circuit board (PCB).

7. The system of claim 1, wherein the mother board communicates between an interactive display screen and a solid state drive of the kiosk.

8. The system of claim 7, wherein the second compute module provides data generates a call from the back end processing to the solid state device.

9. The system of claim 1, wherein the second compute module generates a call to a service reads and converts data from the service or a database call into a readable accessible form.

10. The system of claim 1, further comprising a remote server for exchanging data with at least one of the Raspberry PI compute modules.

11. The system of claim 1, wherein the first compute module performs an input data conversion for a peripheral device.

12. A kiosk apparatus, comprising:
a mother board;
first and second Raspberry Pi type compute modules on the mother board for customizing the mother board, the mother board including an open source breakout board to which the first and second Raspberry PI compute modules are electrically coupled to provide an input/output communication exchange;
a solid state drive for storing data for the communication exchange between the first and second Raspberry PI compute modules or to render portions of data or a temporary storage location from a user input to storage back to a central location; and
a touchscreen display for displaying a result generated by at least one of the first and second Raspberry Pi type compute modules.

13. The kiosk apparatus of claim 12, wherein the mother board includes a printed circuit board (PCB).

14. The kiosk apparatus of claim 12, further comprising a module for communicating between the touchscreen display and the solid state drive.

15. The kiosk apparatus of claim 12, further comprising a network interface for exchanging data generated by at least one of the Raspberry PI compute modules and a remote server.

16. The kiosk apparatus of claim 12, further comprising an NFC reader attached to the custom mother board.

17. The kiosk apparatus of claim 12, wherein the first compute module performs front end processing for displaying an output to a peripheral device, and the second compute module performs back end processing.

18. A method for displaying information on a kiosk, comprising:
activating the kiosk;
request an action;
accepting a user input by a custom mother board in response to activating the kiosk;
making a first call to a front end Raspberry Pi compute module;
making a first call to a back end Raspberry Pi compute module;
processing, at a remote server in communication with the kiosk, an output request in response to the call made to the back end Raspberry Pi compute module;
in response to processing the output request, making a second call to the back end Raspberry Pi compute module;
making a second call to the front end Raspberry Pi compute module; and
displaying information in response to the second call to the front end Raspberry Pi compute module

19. The method of claim 18, wherein:
the requested action includes a request to scan an item for a price;
the custom mother board accepts an input for a price scan;
the first call to the front end Raspberry Pi compute module includes a call to accept input and relay data for larger data sets or for temporary storage use a solid state device;
formatted data is transferred from the front end Raspberry Pi compute module to the back end Raspberry Pi compute module, the transferred formatted data including an action to perform a price lookup;
a service call is made on the server to perform the price lookup;
a result is provided from the server to the back end Raspberry Pi compute module, including price for item data for larger data sets or for temporary storage use a solid state device; and
the price is provided for item data from the back end Raspberry Pi compute module to the front end Raspberry Pi compute module; the method further comprising:
rendering the item price information by a kiosk display; and
displaying the price associated with the item.

20. The method of claim 18, wherein the first call is made to a front end Raspberry Pi compute module to accept the user input and store that onto a solid state drive (SSD) or accept a scan from a reader and convert that into usable data store it on the SSD.

21. The method of claim 18, wherein the second call is made to the back end Raspberry Pi compute module to take the data that was requested and convert from a database or service information to something more manageable for the program and store that information back onto the SSD

22. The method of claim 18, wherein the second call is made to the front end Raspberry Pi compute module to take the data from the back end Raspberry Pi compute module and make it consumable by a user and render it out on the display or print a receipt or report on paper or out through another device for user consumption.

23. The method of claim 18, further comprising performing an information exchange between the front end and back end Raspberry Pi compute modules,
wherein the mother board so that the mother board is unusable in the absence of the information exchange.

24. The method of claim 23, wherein at least one of the front and back end Raspberry Pi compute modules is replaceable with a different first or second compute module that has a validity key that permits the different first or second compute module to communicate with the original remaining first or second compute module.
